(19) United States
(12) Patent Application Publication
(10) Pub. No.: US 2016/0272517 A1
(43) Pub. Date: Sep. 22, 2016

(54) METHOD AND ASSEMBLY FOR TREATING WASTEWATER

(71) Applicant: Colin A. Lennox, Altoona, PA (US)

(72) Inventor: Colin A. Lennox, Altoona, PA (US)

(21) Appl. No.: 15/057,036

(22) Filed: Feb. 29, 2016

Related U.S. Application Data
(60) Provisional application No. 62/176,768, filed on Feb. 27, 2015.

(51) Int. Cl. C02F 1/66; C02F 1/68

(52) U.S. Cl. CPC C02F 1/66; C02F 1/685; C02F 2101/101

(57) ABSTRACT

An alkaline-generating acid-mine-drainage wastewater treatment system is presented. The alkaline generator comprises a rotating reaction chamber that comprises an aggregate hydroxyl ion source, preferably calcium carbonate. The reaction chamber further may comprise grindstones to polish and break the aggregate hydroxyl ion source to prevent pacification of the aggregate hydroxyl ion source. The rotating reaction chamber allows the grindstones to mechanically agitate the aggregate hydroxyl ion source. Further, this allows the alkaline-generator to perform better that the prior art with a much smaller footprint and little-to-no wasted aggregate hydroxyl ion source.

### CROSS REFERENCE TO PRIOR APPLICATIONS

The present application claims the benefit under 35 U.S.C. 119(e) of U.S. Provisional Patent Application No. 62/176,768, filed on Feb. 27, 2015 and titled “Method and Assembly for Treating Wastewater,” which is hereby incorporated by reference in its entirety.

### FIELD OF THE INVENTION

The present disclosure generally relates to the field of water treatment and more specifically to assemblies and methods for treating wastewater associated with acid mine drainage and acid rock drainage impacted waters.

### BACKGROUND OF THE INVENTION

Acid mine drainage (AMD)—also known as: acid metalliferous drainage, hard rock mining impacted water discharges, or acid rock drainage (ARD)—is a process where metal mines, coal mines, and other geological excavation sites undergo a weathering process that causes them to drain acidified and metal cation rich water. Large earth disturbances and anthropologic constructions can cause AMD, especially when certain minerals are present in the rocks of interest, such as sulfides and sulfate rich minerals. AMD pollutes tens of thousands of miles of rivers and streams throughout the US, and the world at large, with dissolved and precipitating metals and acidity. Followed by biotic metabolism of acid producing rocks, notably iron pyrite, this process result in the dissolution of metals found in the impacted strata or tailings pile. The net result is large quantities of acidic, metal rich water that can have various, and generally negative, effects on the surrounding environment and ecosystem.

Attenuation and bioremediation of AMD related waters used in constructed wetlands may require the addition of an alkalinity amendment to act as a buffer to the acidity. The buffered solution has an alkaline pH, roughly neutral pH, or at least less acidic pH. This buffered solution provides the conditions for the abiotic oxidation and subsequent precipitation of dissolved metal cations.

Current methods of treating acid wastewater includes: direct or indirect provision of a hydroxyl ion, such as the addition of Caustic Soda (NaOH), large beds of calcium carbonate lime stone (CaCO₃), and slaked lime powder or slurry (Ca(OH)₂). Each of these methods is effective but come with risks and high costs.

For example, Ordóñez et al. (Mine, Water & Environment. 1999. IMWA Congress. Sevilla, Spain) has proposed a passive static system to treat AMD by creating cascading static slabs of calcium carbonate that drain to another slab, and then to a wetland. However, this approach requires an enormous amount of resources be dedicated to the project to implement it. Further, it is prone to armoring of the alkaline slabs, such that the material is pacified and the apparatus stops working.

Nairn et al. (Mine, Water, & the Environment 19 (2000), 124-133) teach using four 185 m² vertical-flow anaerobic substrate wetlands and surface-flow aerobic settling ponds as an effective method to treat AMD. While their technique did appear to neutralize the AMD, the shear size and cost of the project are staggering. Like with Ordóñez et al., this approach is both expensive and suffers from possible pacification of the alkaline slabs.

Caustic soda and slaked lime are dangerous to handle and transport. Caustic soda also release sodium into the water. Limestone can be inconsistent and can armor, preventing further neutralization unless it is in anoxic or anaerobic conditions, which is impractical in any oxygen rich environment. An example of best management practice with partial or near O2 saturation and available alkalinity is an ALD or aerobic lime drain, also called an aeration ladder. High doses of caustic soda may also cause the precipitation of magnesium and other similar metals which create excess sludge and waste alkalinity. Further, these approaches are expensive in both initial implementation, material cost, and replacement cost.

When considering the long term operations and maintenance of any AMD systems, which is potentially millennium, the major cost becomes maintenance and cost of amendments and associated equipment. Currently, National Pollution Discharge Elimination System (NPDES) permits required by the United States Environmental Protection Agency (USEPA) to structure retired mine site trust fund bonds for 50-75 years of continuous operation and maintenance. When the bond runs out tax payers have to take over the cost of the site or the impact returns. Any increase or decrease in O&M costs directly impact the long term solvency of the bond.

Therefore, it is generally beneficial to create an economical system to control and/or minimize AMD that can be maintained and operated in a cost-efficient manner.

### BRIEF SUMMARY OF THE INVENTION

In a first embodiment of the invention, the present invention includes an alkalinity generator comprising an acidified water inlet, a chemical reactor with a hydroxyl ion (OH⁻) source to chemically react with the acid in the acidified water to form neutralized water, and a neutralized water outlet, thereby treating the acidified water to buffer and neutralize its acid and release the neutralized water back to its environment, wherein the hydroxyl ion source is mechanically agitated.

In another aspect of the invention, the chemical reactor is cylindrical and rotates around its cylindrical axis to provide the mechanical agitation.

In another aspect of the invention, the chemical reactor comprises at least two bearings so that it rotates freely and independently of the rest of the alkalinity generator.

In another aspect of the invention, the bearings are ball bearings.

In another aspect of the invention, the chemical reactor is cylindrical and rotates around its cylindrical axis to provide the mechanical agitation.

In another aspect of the invention, the chemical reactor is cylindrical and a mesh cylinder therein containing the hydroxide ion source rotates around its cylindrical axis to provide the mechanical agitation.

In another aspect of the invention, the acidified water is AMD.

In another aspect of the invention, the OH⁻ ion source is an alkaline mineral.

In another aspect of the invention, the OH⁻ ion source is a weak base capable of buffering the incoming acidic solution.

In another aspect of the invention, the alkaline mineral is limestone (i.e., calcium carbonate).

In another aspect of the invention, the alkaline mineral is in the form of pellets.

In another aspect of the invention, the alkaline mineral pellets are smaller than 2″ in diameter.

In another aspect of the invention, the chemical reactor rotates or tumbles in the presence of open atmosphere.

In another aspect of the invention, the chemical reactor has grooves, channels, or projections around the inner periphery of the reactor such that when acidified water flows through the reactor, the water will translate linear flow into rotational motion of the reactor.

In another aspect of the invention, heavy small objects can be added to the chemical reactor such that when the chemical reactor rotates or tumbles, the small heavy objects crush the OH⁻ source into a finer particle.

### BRIEF DESCRIPTION OF THE DRAWINGS

The following drawings illustrate by way of example and are included to provide further understanding of the invention for purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature or a feature with similar functionality. In the drawings:

FIG. 1 illustrates a schematic representation of a first embodiment of the AMD treatment apparatus according to the present invention.

FIG. 2 illustrates an exploded view of the first embodiment of the AMD treatment apparatus according to the present invention.

FIG. 3 illustrates an exploded view of a second embodiment of the AMD treatment apparatus according to the present invention.

FIG. 4 illustrates an exploded view of a third embodiment of the AMD treatment apparatus according to the present invention.

### DETAILED DESCRIPTION OF THE INVENTION

The present invention exposes acid-rich water (generally AMD) to OH⁻ ions to neutralize the low pH and then releases the product back into its environment. Acid-rich water may also comprise metal cations dissolved therein. However, when acidity is treated to create a neutral pH, this will often destabilize the acid-stabilized solubility of the metal cations, causing them to precipitate out of the solution as water-insoluble minerals. Therefore, the present invention is effectively treating both acidity and metal content, and armoring precipitate of the alkalinity source. However, toward that end an MRU can be added in tandem to the present invention in order to further treat soluble metal cations. Generally, metal precipitation is an abiotic process that requires oxygen, and therefore may happen in an open environment. For example, aluminum and iron generally precipitate when neutralizing acidic water, at pH levels of about 4.5 and about 5.0 respectively.

Further, some suspended compounds, such as insoluble minerals or pure metals, may pass through the present alkalinity generator without any significant effect. Alternatively, insoluble minerals or pure metals may pass through the alkalinity generator but may be oxidized as they pass through. Such suspended contaminants will be flushed through the alkalinity generator as part of the effluent.

OH⁻ Ion Source

The OH⁻ ion source can be any OH⁻ source that does not harm the in situ environment. For example, while sodium hydroxide (aqueous form) and (slaked lime) neutralize acidic water, because they are strong bases, the base would completely disassociate (i.e., dissolve) and instead of making neutral output water, it would make highly alkaline water with undissolved hydroxide powder to further contaminate the ecosystem by introducing excess alkalinity, and then when it's washed away or completely reacted, then it would fail to treat the acidic water supply. Therefore it is clear that the OH⁻ ion source must either be contained in the chemical reactor or be metered to prevent over-exposure of the environment to alkalinity. Therefore, we note two distinct systems: passive (e.g., calcium carbonate in the chemical reactor; contained OH⁻ ion source) and active (e.g., small concentrations of concentrated sodium hydroxide added at a metered rate as the OH⁻ ion source; does not require a contained OH⁻ ion source).

Both passive and active systems have a finite amount of OH⁻ ion source, and therefore both systems require periodic recharge.

Passive Systems

For the purpose of this disclosure, “passive” means systems wherein the OH⁻ ion source are not added over time via metering and bulk amounts of OH⁻ ion source are dumped into the chemical reactor at a time. Instead passive systems require that the OH⁻ ion is naturally metered, by buffering or slow dissolution. Therefore, it is critical that passive systems require that the OH⁻ ion source is not water soluble.

In passive systems, fine powder is insufficient as the OH⁻ ion source because it becomes impractical to contain the powder (anything less than 100 microns) from being washed away, whereas larger particulates or even rock sized chunks can be contained with mesh screens or other technologies. In such passive systems, the lower threshold of the OH⁻ ion source can be as low as about 100 microns, such as about 250 microns or about 500 microns, but is preferably about a millimeter, about 2 millimeters, about 5 millimeters, or even about 1 centimeter. Most importantly, the lower particle size threshold must be set so that most or alternatively substantially all of the OH⁻ ion source can be contained by the present invention's chemical reactor without washing out.

In another embodiment of the invention, non-solid physical forms of the OH⁻ ion source are acceptable even in passive systems, assuming they can be contained. For example, a highly-concentrated partitioned liquid coating can be used if it is designed such that it only slowly dissolves in the acidified water to prevent it from being washed away and can acceptably buffer and neutralized the acidified water going therethrough.

In passive systems, strong base sources are generally not appropriate because they would quickly dissolve, creating an alkaline environment when refreshed of OH⁻ ion source followed by an acidic environment when depleted of OH⁻ ion source.

The rate at which OH⁻ ion source is used in passive systems is dependent upon several factors. It may be beneficial to allow small amounts of OH⁻ ion source to release from the chemical reactor in order to create an alkaline environment to allow slower oxidizing metal cations (e.g., manganese) to properly oxidize completely. Those skilled in the art would recognize such metal cations may take hundreds or thousands of tons of limestone, and high square footage wetlands to properly oxidize manganese, but by allowing small amounts of microfine precipitates to escape, then such metal cations may still be substantially oxidized to completion. See “Grindstones” below for more.

The frequency of limestone recharge is dependent on the amount of acid it is exposed to (i.e., intended reaction rate; controlled by influence pH and flow), dissolved metal load (i.e., ion concentration multiplied by volume by time; controlled primarily by flow), amount of OH⁻ ion source allowed to escape as microparticulate (i.e., grinding rate; controlled by rotating, tumbling, the nature of the grindstones, and the amount of the grindstones), and side reactions (e.g., oxidation with air).

Passive systems according the present invention are relatively low cost, require smaller amounts of material than the prior art, and boast near 100% material consumption, which makes the systems of the present invention highly desirable.

The advantage of the passive system is simplicity. It does not require any hardware to charge the chemical reactor with OH⁻ ion source or meter the OH⁻ ion source. A user would just have to charge it with OH⁻ ion source buffer and walk away.

Active Systems

In active systems, powders and non-solid physical forms of the OH⁻ ion source can be used as they can be metered to control the chemical reaction from producing an overly alkaline environment.

Active systems may use strong bases as the OH⁻ ion source as they can properly meter them. The metering rate can be to target whatever amount of excess OH⁻ ion source to be put into the environment.

The advantage of an active system is robustness. While it does require hardware to charge the chemical reactor with a hydroxyl source and meter the OH⁻ ion source, it can use far more OH⁻ ion sources. They can use effectively all of the OH⁻ ion sources as passive systems, and use other materials as well. Active systems are more complex and costly, therefore more likely to fail, malfunction, and run out of bond money sooner than later.

Owing to the possibility of armoring (i.e., a thin film of inactive material forming over the active materials rendering them unable to perform their chemistries), it is important that even in armoring, the reaction chamber is rotated periodically or continuously.

Further, aggregate sized systems require containment of the OH⁻ ion source in the reaction chamber, just like passive systems. Otherwise OH⁻ ion source material will escape the reaction chamber out of the reactor before they are completely reacted. Escaped OH⁻ ion source materials will become coated with inactive materials that separate the OH⁻ ion sources from the acid water, raising the cost of operating the unit due to wasted materials and creating deposits of deactivated alkaline material in the ecosystem.

Alkaline Mineral OH⁻ Ion Source

The OH⁻ ion source is preferably an alkaline mineral. Herein an alkaline mineral is any mineral that will react with pure water under standard temperature and pressure conditions (STP) to release OH⁻ ions into the water. Preferably the alkaline mineral is a weak base mineral. Preferred minerals include minerals based on magnesium, sodium, copper, iron, manganese, and potassium cations, and particular those based upon calcium cations, such as alkaline reserve minerals. Limestone (i.e., calcium carbonate) is a particularly preferred calcium mineral.

Calcium carbonate has the carbonate ion (CO₃²⁻) that acts as a Lewis base:

CaCO₃(s)+2H⁻(aq)→Ca²⁺(s)+H₂O(l)+CO₂(g)

Therefore calcium carbonate can react with the acidic water and neutralize it.

Because the reaction vessel acts like a rock tumbler, the quality of the material is no longer as important as in a static limestone bed or anoxic lime drain, allowing for lower purities of calcium carbonate stone to be used, thereby reducing material costs. Replenishment of calcium carbonate stone, or clearing accumulated clogs of precipitated material, can be accomplished by removing one end cap or the other to add more limestone. More material can be pushed into the cylinder using a “cannon swab” like device comprising a pole and a flat portion to push the material farther to the center, clearing room to add more stone. Or additionally the alkalinity generator can have a reactor access that will allow it to be charged.

The particle size of the OH⁻ ion source should not be so large that the surface area is so low that it cannot function for its intended purpose. Therefore, the upper size limit for the particle sizes can be 0.10′, 0.25′, 0.5′, 1.0′, 1.5′, 2.0′, 2.5′, 3.0′, 3.5′, 4.0′, 4.5′, or even 5.0′. Preferably the upper size limit is particles 2″ large. Most preferably the particle size is 2A or less using nominal coarse aggregate specs (or PA 2A, 2RC, or CR6).

A mesh screen can be used to prevent aggregate-sized OH⁻ ion source from escaping the reaction chamber. The mesh screen can be selected to allow a small and beneficial portion of microparticulate OH⁻ ion source escape but not large aggregate from escaping. For example, sheet and hoop iron standard (nominal) nos. 1, 2, 3, 4, 5, 6, 7, 8, 9, 10, 11, 12, 13, 14, 15, 16, 17, 18, 19, 20, 21, 22, 23, 24, 25, 26, 27, 28, 29, and 30 may be appropriate sizes, based upon desired pore size.

Rotation

Rotation in the present invention creates mechanical collisions and friction, which serves to break aggregate into smaller portions increasing surface area and polishes the aggregate to prevent a layer for film of inactive material from forming on the aggregate surface. Further it slows the flow through the reactor as this breaks up laminar flow or surface flow, which allows the OH⁻ ion source material more time to neutralize acid, and prevents internal laminar flows in flow paths that are not exposed to the surface of the OH⁻ ion source material. Further, rotation also promotes gas exchange, allowing O₂ to dissolve in the water and allows CO₂ to escape, promoting quicker reactions under Le Chatelier's Principle. Further, available oxygen allows for metal ion oxidation, precipitation, and adhesion to the calcium carbonate or downstream of the alkalinity generator. Therefore, rotation is critical.

Rotating or tumbling the present invention can be done by an external source, such as by harnessing environmental forces, such as having fins on the outer periphery of the housing that dip into an external stream, thereby tumbling the device, having angled fins on the internal periphery of the reaction chamber such that as wastewater flows through the device, it induces torque, or having a water wheel that transfers its torque via belts or gears. External rotating sources can include motors. Additionally, the external source can be fluid streams, such as wind-powered or water-powered. The external rotating sources can transfer rotation motion to the alkalinity generator using any rotational motion transfer means, such as drivetrains, belts, chains, gears, cogs, non-compressible fluids, and sprockets.

Additionally rotation can be achieved via internal means if the flow of the water is sufficient to overcome the static friction. For example, fins, projections, or channels can be disposed inside the rotating cylinder, such that as wastewater travels down the axis of rotation, it puts pressure on those fins, projections, or channels to induce torque.

The entire apparatus may rotate with external bearings, or there can be bearings built into the device itself so only a portion of the device rotates. For examples, bearings can be built into the side walls of a cylindrical reaction chamber, such that only the reaction chamber rotates. Additionally, a rotating chamber can be provided inside a stationary chamber, such as a reaction chamber inside a housing or a rotating cage rotating inside of the reaction chamber. Preferably the bearing is a ball-bearing. More preferably the ball bearings are built into the flat walls of a cylindrical reaction chamber such that the cylindrical reaction chamber can rotate freely and independently of the rest of the apparatus.

The rotational speed can be chosen to maximize the desired grinding and polishing properties. If the rotational speed is too high, then OH⁻ ion source material will grind too fine, too quickly and escape, wasting material. Further, the constant collisions on the rotating portions of the alkalinity generator will wear the alkalinity generator, causing the device to “go bad” quicker. If the rotational speed is too slow, then a layer of inactive material will build up on the OH⁻ ion source material it will effectively be deactivated. Therefore, the skilled artisan would take time to choosing what rotational speed to use for the alkalinity generator. Further, as would be understood by one of ordinary skill in the art, the rotational speed can be selected by using gear-to-gear ratios or the like when transferring torque into the present device from an external source, or by selecting the angle of the fins on the inside of the rotating portion of the alkalinity generator in the event the torque source is the wastewater itself.

The rotating portion of the present invention can be supported on wheels to assist in actually rotating the rotating portion. Additionally if the rotating portion is a cylinder inside another cylinder, then the inner rotating portion can be supported by wheels mounted to the outer cylinder, such that the inner cylinder can freely rotate without putting load on the bearings.

Grindstones

As noted above, neutralizing acidic water may cause metal minerals to oxidize and precipitate from solution, which may creates a scaling or armoring on the OH⁻ ion source (sometimes known as armoring or scaling), rendering the OH⁻ ion source material ineffective. In order to counteract this phenomenon, grindstones (also known as “cannonballs” or gastrolites) may be added to the system, such that when the system rotates or tumbles, they mechanically polish the active material, removing armoring through erosion.

Any material harder than the OH⁻ ion source material can be used, but preferable grindstones are those that only minimally harm the chemical reactor and can withstand the tumbling and/or rocking of the chemical reactor.

Exemplary grindstones can be gastrolites, especially when the OH⁻ ion source is calcium carbonate.

Such polishing may create microparticulates that escape the reaction chamber. When using weak base minerals, this is actually beneficial as those microparticulate minerals will be relatively dilute but will continue to buffer the released water as it travels back into the ecosystem and further dilutes.

Any precipitated metals, such as aluminum and iron, may be flushed from the reaction chamber to be captured, treated, and sequestered by an MRU.

Nested Cylinders

As noted elsewhere in this specification, the alkalinity generator may comprise nested cylinders to perform the present goals. In general, when this is the case, only the inner cylinder will rotate. As such, it is possible to bury the entire alkalinity generator to thermally insulate the alkalinity generator or to protect the alkalinity generator from human interference.

The inner cylinder can be either a mesh cylinder such that the outer cylinder actually seals the contents of the reaction chamber. Or the inner cylinder can be a solid cylinder that alone acts as the reaction chamber, and the outer cylinder acts as only a housing.

Inlet and Outlet

The inlet of the apparatus allows influent to enter the reaction chamber. The outlet of the apparatus allows effluent to leave the reaction chamber. The outlet may be off center. If it is lowered off-center of the axis of the cylinder's rotation, then resident time for AMD in the reaction chamber is reduced. Further, it becomes easier for solid materials in the reaction chamber to escape when no mesh or screen is present. However, when it is raised off-center of the axis of the cylinder's rotation, then resident time for the AMD is increased, and it becomes practical to operate without a screen as larger aggregates will settle. Further, it is preferred that the outlet is a larger gauge than the inlet to ensure that the reaction chamber can allow effluent to escape faster than influent can enter the reaction chamber.

Anaerobic Bioreactor

An anaerobic bioreactor, whose purpose is to generate a nutrient solution, can be added to the lower pH influent entering the present invention where the combined flow is well aerated and mixed.

Metal Removal Unit

An MRU can be placed inline after the present invention. The purpose of the MRU is to remove metals from the fluid stream. By putting the MRU after the present invention, the MRU will have a higher efficiency as acid-soluble, water-insoluble metals will be insoluble. This will also increase the effectiveness of the present metal-precipitation.

Further, the MRU may capture contaminant suspended particles, such as metal colloids or metal containing minerals, and process them to remove them from the wastewater stream.

The MRU is be capable of physically capturing excess OH⁻ ion source material and holding it, such that if the alkalinity generator fails or malfunctions, the MRU may be able to have some levels of alkalinity generation effect.

### EXAMPLE 1

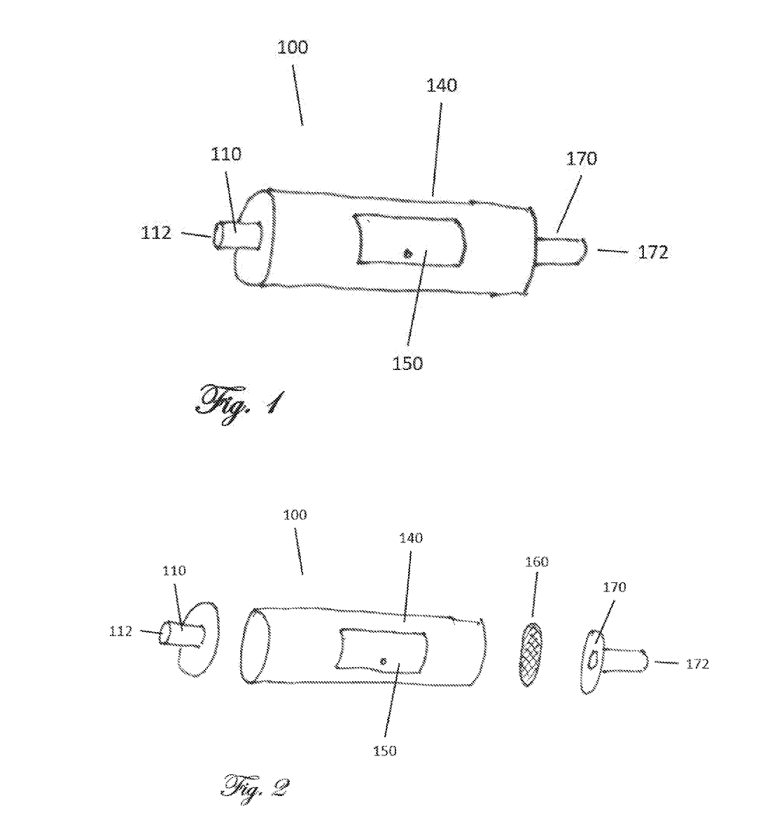

A first embodiment of a passive alkalinity generator in accord with the above disclosure is shown. As is shown in FIGS. 1 and 2, passive apparatus 100 is cylindrical in shape, so that it may rotate about its cylindrical axis. Input 110 allows influent AMD or other acidic wastewater to enter through input port 112. The influent AMD enters reaction chamber 140, where it is exposed to calcium carbonate or another such OH⁻ ion source. A neutralization chemical reaction takes place. In the case of calcium carbonate, CO₂ gas, water, and calcium cations are created in the chemical reaction. The reaction chamber 140 rotates about its cylindrical axis, which in turns causes physical agitation inside the reaction chamber 140, grinding and polishing the OH⁻ ion source. This process prevents armoring of the OH⁻ ion source, allowing it to continue reacting. After the OH⁻ ion source has reacted with the AMD wastewater and neutralized it, it may exit the reaction chamber through output port 172 of output 170. Effluent screen 160 prevents OH⁻ ion source aggravate that has not been pulverized to the microparticulate level from exiting the reaction chamber 140.

In this embodiment, the entire reaction chamber 140 spins under the influence of external torque (not shown). Non-limiting examples of external torque could be a sprocket on one of or both of input 110 and/or output 170, or a belt mechanism attached to the body of reaction chamber 140 that is also connected to a motor. It is also critical to realize that in order to rotate reaction chamber 140, then there must be a pivot point that allows rotation. In this embodiment, such pivot points can be built into input 110 and output 170, or the entire assembly 100 can rotate and the pivot points are external to the assembly. Further, they can be built into reaction chamber 140 itself, such that only some of the walls or part of the cylinder of the reaction chamber 140 rotates.

Restocking of the calcium carbonate or other OH⁻ ion source can be accomplished by access to the inside of the reaction chamber using reaction chamber access 150. Reaction chamber access 150 can also be used to clean to internals of the reaction chamber 140, inspect reaction chamber 140, or repair reaction chamber 140 in the event of malfunction or failure.

### EXAMPLE 2

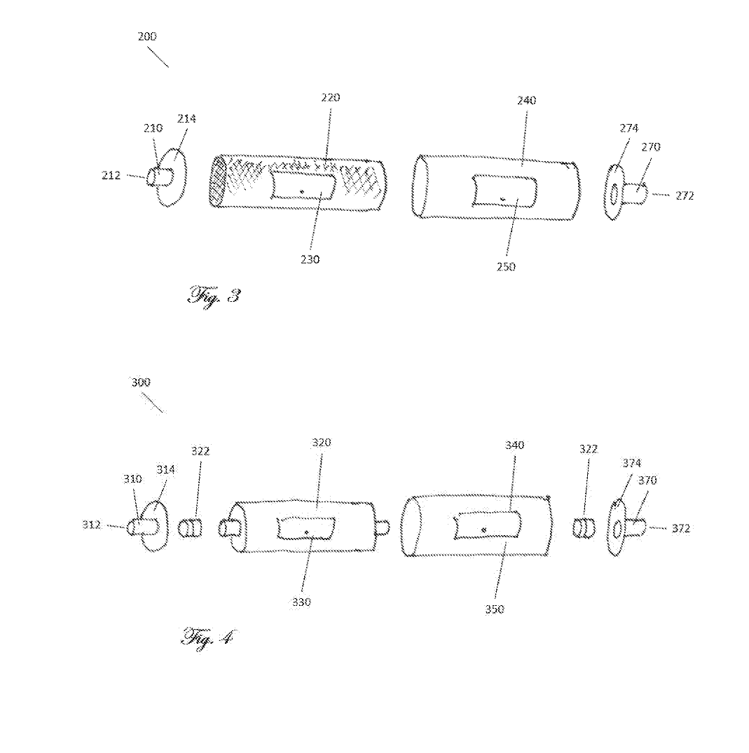

A second embodiment of a passive alkalinity generator in accord with the above disclosure is shown. As is shown in FIG. 3, passive apparatus 200 is cylindrical in shape, so that it may rotate about its cylindrical axis. Input 210 allows influent AMD or other acidic wastewater to enter through input port 212. Inner tumbler 220 is installed into reaction chamber 240. Inner tumbler is a mesh cage that contains OH⁻ ion source (e.g., calcium carbonate) aggregate to prevent wasting reagents and contaminating the external environment. Plate flanges 214 and 274 mate with the edge of reaction chamber 240 to create a liquid-tight seal at the first and second ends of the apparatus 200, respectively. The plate flanges 214 and 274 may mate with reaction chamber 240 with any conventional method, such as welding or screwing. Reversible connections (e.g., screwing) are preferred so that maintenance can be performed and inner tumbler 220 may be replaced. The influent AMD enters reaction chamber 240, where it is exposed to calcium carbonate or another such OH⁻ ion source. A neutralization chemical reaction takes place. In the case of calcium carbonate, CO₂ gas, water, and calcium cations are created in the chemical reaction. The reaction chamber 240 is stationary, but inner tumbler 220 rotates about its cylindrical axis within the reaction chamber, which in turns causes physical agitation inside the reaction chamber 240, grinding and polishing the OH⁻ ion source. This process prevents armoring of the OH⁻ ion source, allowing it to continue reacting. After the OH⁻ ion source has reacted with the AMD wastewater and neutralized it, it may exit reaction chamber 240 through output port 272 of output 270. Inner tubler 220 prevents OH⁻ ion source aggravate that has not been pulverized to the microparticulate level from exiting the reaction chamber 240.

In this embodiment, only the inner tumbler 220 spins under the influence of external torque (not shown). Non-limiting examples of external torque could be a belt mechanism attached to the inner tumbler 220 that is also connected to a motor.

Restocking of the calcium carbonate or other OH⁻ ion source can be accomplished by aligning reaction chamber access 250 and inner tumbler access 230 and opening both. Accesses 250 and 230 can also be used to clean the internals of the reaction chamber 240 without disassembly of the entire apparatus 200, inspect reaction chamber 240, or repair reaction chamber 240 in the event of malfunction or failure.

In this embodiment, it must be noted that inner tumbler 220 is most effective when it is relatively flush with the inner periphery of the reaction chamber 340 to prevent a channel of AMD wastewater of traveling the length of the reaction chamber 340 without actually reacting with the calcium carbonate or other OH⁻ ion source.

### EXAMPLE 3

A third embodiment of a passive alkalinity generator in accord with the above disclosure is shown. As is shown in FIG. 4, passive apparatus 300 is cylindrical in shape, so that it may rotate about its cylindrical axis. Input 310 allows influent AMD or other acidic wastewater to enter through input port 312. Rotating reaction chamber 320 is installed into housing 340. Rotating couples 322 attach the input 310 to rotating reaction chamber 320 and output 370 to rotating reaction chamber 320. Rotating couples 322 allow free rotation such that rotating reaction chamber 320 may freely rotate without torqueing input 310 or output 370. Plate flanges 314 and 374 mate with the edge of housing 340 to create a liquid-tight seal at the first and second ends of the apparatus 300, respectively. The plate flanges 314 and 374 may mate with the housing 340 with any conventional method, such as welding or screwing. Reversible connections (e.g., screwing) are preferred so that maintenance can be performed and inner tumbler 320 may be replaced. The influent AMD enters rotating reaction chamber 320, where it is exposed to calcium carbonate or another such OH⁻ ion source. A neutralization chemical reaction takes place. In the case of calcium carbonate, CO₂ gas, water, and calcium cations are created in the chemical reaction. The housing 340 is stationary, but rotating reaction chamber 320 rotates about its cylindrical axis within the reaction chamber, which in turn causes physical agitation inside the housing 340, grinding and polishing the OH⁻ ion source. This process prevents armoring of the OH⁻ ion source, allowing it to continue reacting. After the OH⁻ ion source has reacted with the AMD wastewater and neutralized it, it may exit rotating reaction chamber 320 through output port 372 of output 370. Rotating reaction chamber 320 prevents OH⁻ ion source aggravate that has not been pulverized to the microparticulate level from exiting the housing 340 by using a screen (not shown) at the exit of rotating reaction chamber 320.

In this embodiment, only the rotating reaction chamber 320 spins under the influence of external torque (not shown). Non-limiting examples of external torque could be a belt mechanism attached to the rotating reaction chamber 320 that is also connected to a motor.

Restocking of the calcium carbonate or other OH⁻ ion source can be accomplished by aligning housing access 350 and rotating reaction chamber access 330 and opening both. Accesses 350 and 330 can also be used to clean to internals of the housing 340 without disassembly of the entire apparatus 300, inspect housing 340, or repair housing 340 in the event of malfunction or failure.

It will also be recognized by those skilled in the art that, while the invention has been described above in terms of preferred embodiments, it is not limited thereto. Various features and aspects of the above described invention may be used individually or jointly. Further, although the invention has been described in the context of its implementation in a particular environment, and for particular applications (e.g. acid removal for AMD), those skilled in the art will recognize that its usefulness is not limited thereto and that the present invention can be beneficially utilized in any number of environments and implementations where it is desirable to remove acid, such as in city storm drains prone to acid rain, in chemical processes, and any other environment exposed to acid water. Accordingly, the claims set forth below should be construed in view of the full breadth and spirit of the invention as disclosed herein.

1. A method of treating acidic wastewater, comprising the steps of:
providing an influent acidic water stream into a reaction chamber;
providing a hydroxyl ion source in the reaction chamber;
tumbling or rotating the reaction chamber;
neutralizing the acidic water with the hydroxyl ion source to create a neutralized water; and
draining the neutralized water the reaction chamber as the effluent.

2. The method of claim 1, wherein the reaction chamber is cylindrical and rotates about its cylindrical axis.

3. The method of claim 2, wherein the reaction chamber is an inner cylinder inside of an outer cylindrical housing.

4. The method of claim 1, wherein the hydroxyl ion source is an aggregate hydroxyl ion source.

5. The method of claim 4, wherein a mesh cylinder bounds the aggregate hydroxyl ion source and rotates arounds its cylindrical axis inside of a cylindrical reaction chamber.

6. The method of claim 1, wherein the hydroxyl ion source is calcium carbonate.

7. The method of claim 4, wherein the aggregate hydroxyl ion source is calcium carbonate.

8. The method of claim 4, wherein the aggregate hydroxyl ion source has an aggregate size of 2 inches or less in diameter.

9. The method of claim 1, wherein the influent acidic water stream is acid mine drainage.

10. The method of claim 1, additionally comprising the step of providing a material harder than the hydroxyl ion source that will polish and/or grind the hydroxyl ion source when the reaction chamber rotates.

11. An apparatus to treat acidic wastewater, comprising:
a cylindrical reaction chamber;
a hydroxyl ion source disposed in the reaction chamber;
an inlet into the reaction chamber;
an outlet from the reaction chamber;
bearings integrated, welded, or otherwise attached to the reaction chamber so that the reaction chamber can rotate freely and independently of the rest of the apparatus; and
a torque source coupled to the reaction chamber to rotate the reaction chamber about its cylindrical axis.

12. The apparatus of claim 11, wherein the hydroxyl ion source is an aggregate hydroxyl ion source.

13. The apparatus of claim 12, additionally comprising a mesh screen against an outlet wall of the reaction chamber such that effluent may escape the reaction chamber but at least a portion of the aggregate hydroxyl ion source cannot escape the reaction chamber due to being too large.

14. The apparatus of claim 12, wherein the hydroxyl ion source is calcium carbonate.

15. The apparatus of claim 11, wherein the hydroxyl ion source is calcium carbonate

16. The apparatus of claim 12, wherein the aggregate hydroxyl ion source has a aggregate size of 2 inches or less in diameter.

17. The apparatus of claim 11, additionally comprising a material harder than the hydroxyl ion source mixed the hydroxyl ion source in the reaction chamber that will polish and/or grind the hydroxyl ion source when the reaction chamber rotates.

18. The apparatus of claim 11, additionally comprising a static cylindrical housing disposed around the cylindrical reaction chamber, wherein the static cylindrical housing does not rotate.

19. An apparatus to treat acidic wastewater, comprising:
a cylindrical reaction chamber;
a cylindrical mesh container disposed within the cylindrical reaction chamber;
a hydroxyl ion source disposed in the cylindrical mesh container of a particle size to be generally bound by the cylindrical mesh container;
an inlet into the cylindrical mesh container;
an outlet from the reaction chamber;
bearings integrated, welded, or otherwise attached to the cylindrical mesh container so that the cylindrical mesh container can rotate freely and independently of the rest of the apparatus; and
a torque source coupled to the reaction chamber to rotate the cylindrical mesh container about its cylindrical axis,
wherein the cylindrical reaction chamber is stationary.

20. The apparatus of claim 19, additionally comprising a material harder than the hydroxyl ion source mixed the hydroxyl ion source in the cylindrical mesh container that will polish and/or grind the hydroxyl ion source when the cylindrical mesh container rotates, and wherein the hydroxyl ion source is aggregate calcium carbonate.
